(19) United States
(12) Patent Application Publication
(10) Pub. No.: US 2016/0012382 A1
(43) Pub. Date: Jan. 14, 2016

(54) MANAGEMENT METHOD AND SYSTEM FOR TIME-OFF SCHEDULE OF DELIVERY WORKER

(71) Applicant: NIPPON GAS CO., LTD., Tokyo (JP)

(72) Inventors: Shinji Wada, Tokyo (JP); Shingo Dekamo, Tokyo (JP)

(21) Appl. No.: 14/764,075

(22) PCT Filed: Jan. 30, 2014
(86) PCT No.: PCT/JP2014/000500

§ 371 Date: Jul. 28, 2015

(30) Foreign Application Priority Data
Jan. 31, 2013 (JP) 2013-017789

(51) Int. Cl. G06Q 10/06

(52) U.S. Cl. CPC G06Q 10/063116

(57) ABSTRACT

The timing for delivery of a LP gas cylinder depends on various factors such as the manner in which a customer uses gas. Thus, the timing cannot be set to a particular date. However, in order to maintain deliverymen's motivation/morale and to deal with the deliverymen's fatigue, leave schedules for the deliverymen need to be impartially created. The invention designates holidays for deliveryman data with the same delivery base and the same territory, determines whether the total number of designated holidays is equal to or larger than a predetermined number, and when the total number of designated holidays is smaller than the predetermined number, additionally designates holidays In accordance with a predetermined rule.

### TECHNICAL FIELD

The present invention relates to a method and a system for managing a leave schedule of a deliveryman.

### BACKGROUND ART

LP gas is classified into imports from gas producing countries and domestic production including by-products from production processes of petroleum products. Import terminals where LP gas carried from gas producing countries by tankers is stored and petroleum refinery terminals are referred to as primary terminals. LP gas is loaded into domestic vessels or tank trucks at a primary terminal and shipped to secondary terminals that are transit stations for LP gas transportation which are located longshore or inland. Then, the LP gas carried to a secondary terminal is transported to LP gas filling stations in various locations (delivery bases), where gas cylinders are filled with the LP gas.

Gas cylinders filled with LP gas at each delivery base are delivered by deliverymen to customers such as general homes, housing complexes, and business offices. Used gas cylinders at the customers' homes are replaced with filled gas cylinders and collected at the delivery base. Furthermore, for each delivery base, a fixed delivery area for which a deliveryman is responsible is set. The deliveryman visits the customers' homes in the delivery area to deliver gas cylinders to the customers, based on a delivery list.

The timing for delivery of a gas cylinder depends on the manner in which the customer uses gas, the capacity of the gas cylinder, and an installed cylinder count (number of installed cylinders). Thus, the timing for delivery of a gas cylinder cannot be set to a particular date. To deal with this, deliverymen within the same territory of the same delivery base take leave in rotation, instead of taking regular holidays.

However, in order to maintain the deliverymen's motivation/morale and to deal with the deliverymen's fatigue, it is desirable to allow the deliverymen to impartially take more consecutive holidays. However, when a manager satisfies each deliveryman's desire to take leave, a sense of impartiality may be lost. Thus, a certain rule may be established for setting of holidays. Furthermore, it is an important challenge to prevent setting of holidays from imposing a burden on the manager. Moreover, the usage of LP gas depends on the season, and delivery business involves an off season and a busy season. Consequently, the number of holidays to be taken by the deliveryman needs to be adjusted in units of given periods, for example, every month.

### SUMMARY OF INVENTION

### Technical Problem

The present invention has been developed in view of these problems. An object of the present invention is to impartially and automatically create a leave schedule for a deliveryman in the LP gas business.

### Solution to Problem

To accomplish such an object, the present invention provides a method for creating a leave schedule of a given period for a LP gas deliveryman, the method including:

designating a reference day+n days within the given period as holidays for deliveryman data with an identical delivery base and an identical territory, the n being an integer and being shifted by a given number for each of the deliveryman data; designating holidays for the deliveryman data at given time intervals based on the designated holidays;
determining whether a total number of the designated holidays is equal to or larger than a predetermined number for each of the deliveryman data; and
additionally designating holidays for the deliveryman data with the total number smaller than the predetermined number.

Furthermore, in the invention described in the preceding paragraph, additionally designating holidays includes designating the holidays in order of given priority. Moreover, the given priority is such that a highest priority is given to a Sunday of a week with a smallest weekly number of holidays in the given period, a second highest priority is given to a Saturday of the week, and a third highest priority is given to a day next to the designated holiday of the week. Additionally, in the invention described in the preceding paragraph, additionally designating holidays includes designating days within the given period as holidays in order of decreasing number of points given to each of the days in accordance with a given rule. In addition, the points are given to Sundays and Saturdays within the given period which are not the designated holidays, and an additional number of the points are given to a day next to the designated holiday.

### Advantageous Effects of Invention

As described above, the present invention enables a leave schedule for a LP gas deliveryman to be impartially and automatically created based on a predetermined rule.

### BRIEF DESCRIPTION OF DRAWINGS

FIG. 1 is a block diagram depicting a server configuration according to one embodiment of the present invention.

FIG. 2 is a diagram depicting a basic leave schedule according to the one embodiment of the present invention.

FIG. 3 is a diagram depicting the monthly number of holidays according to the one embodiment of the present invention.

FIG. 4 is a diagram depicting an example of data stored in a deliveryman data storage unit according to the one embodiment of the present invention.

FIG. 5 is a diagram depicting a leave schedule to which a priority system according to the one embodiment of the present invention is applied.

FIG. 6 is a diagram depicting a leave schedule to which a point system according to the one embodiment of the present invention is applied.

FIG. 7 is a flowchart illustrating a process of creating a basic leave schedule according to the one embodiment of the present invention.

FIG. 8 is a flowchart illustrating a process of creating a leave schedule to which the priority system according to the one embodiment of the present invention is applied.

FIG. 9 is a flowchart illustrating a process of creating a leave schedule to which the point system according to the one embodiment of the present invention is applied.

### DESCRIPTION OF EMBODIMENTS

A method and a system according to an embodiment of the present invention will be described below in detail with reference to the attached drawings.

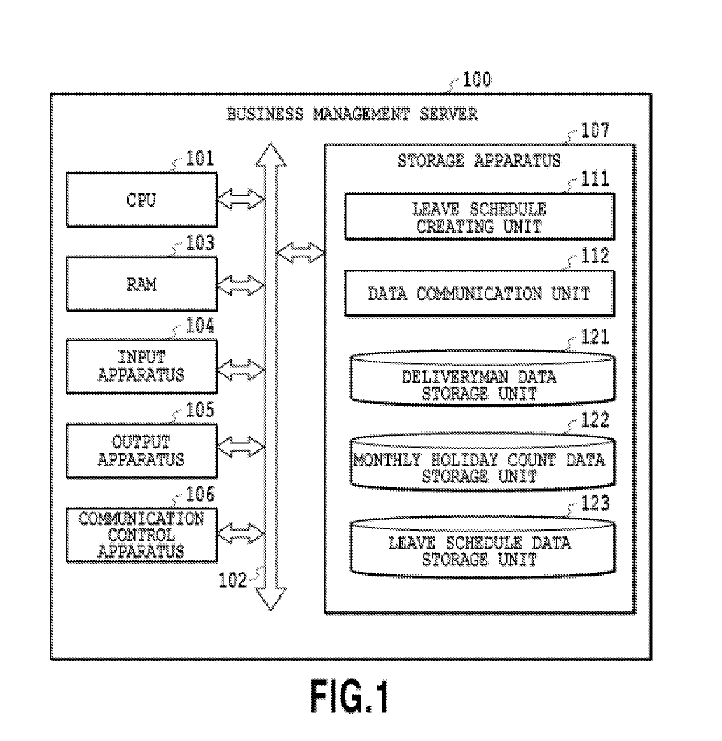

With reference to a block diagram in FIG. 1, a configuration of a business management server 100 that carries out the present invention will be described.

The business management server 100 is configured such that a CPU 101 couples via a system bus 102 to a RAM 103, an input apparatus 104, an output apparatus 105, a communication control apparatus 106, and a storage apparatus 107 including a nonvolatile storage medium (ROM, HDD, or the like). The storage apparatus 107 includes a program storage area in which software programs providing functions according to the present invention are stored and a data storage area in which data used for or created by the software programs are stored. Unit in the program storage area described below are actually independent software programs and routines or components thereof. These are initiated by the CPU 101, loaded into a work area in the RAM 103, and sequentially executed to provide functions.

Only those of the storage unit provided in the data storage area in the business management server 100 which are related to the present invention are as follows: a deliveryman data storage unit 121, a monthly holiday count data storage unit 122, and a leave schedule data storage unit 123. Each of the storage units is a given storage area secured in the storage apparatus 107.

The deliveryman data storage unit 121 stores data on deliverymen. The deliveryman data includes the deliverymen's names, delivery bases to which the deliverymen belong, and the deliverymen's territories.

The monthly holiday count data storage unit 122 stores data on the monthly number of holidays to be designated for the deliverymen. The monthly number of holidays includes data on the months and the number of holidays designated for each month.

The leave schedule data storage unit 123 stores data on a leave schedule for each of the deliverymen. The leave schedule data includes data on the identifiers of the deliverymen and years, months, and days when holidays were set.

Only those unit in the software program stored in the program storage area in the business management server 100 which are related to the present invention are as follows: leave schedule creating unit 111 and data communication unit 112.

The leave schedule creating unit 111 acquires the deliveryman data from the deliveryman data storage unit 121, acquires the monthly holiday count data from the monthly holiday count data storage unit 122, and creates leave schedule data for each deliveryman.

The data communication unit 112 distributes created leave schedule data to another computer. Furthermore, the data communication unit 112 receives a request for leave schedule data from another computer.

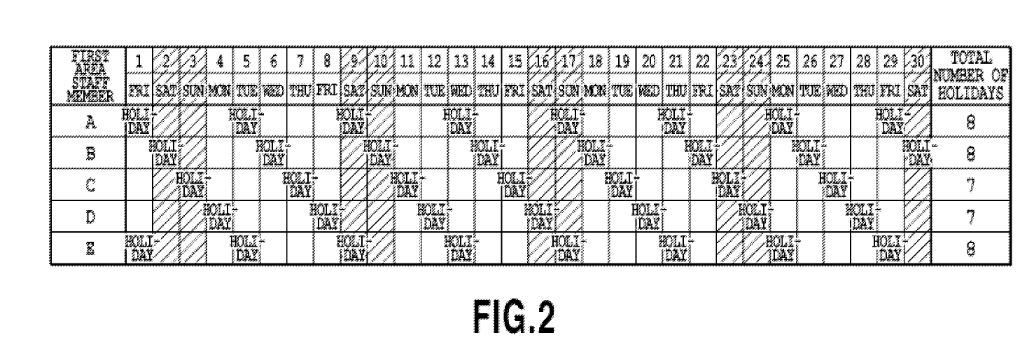

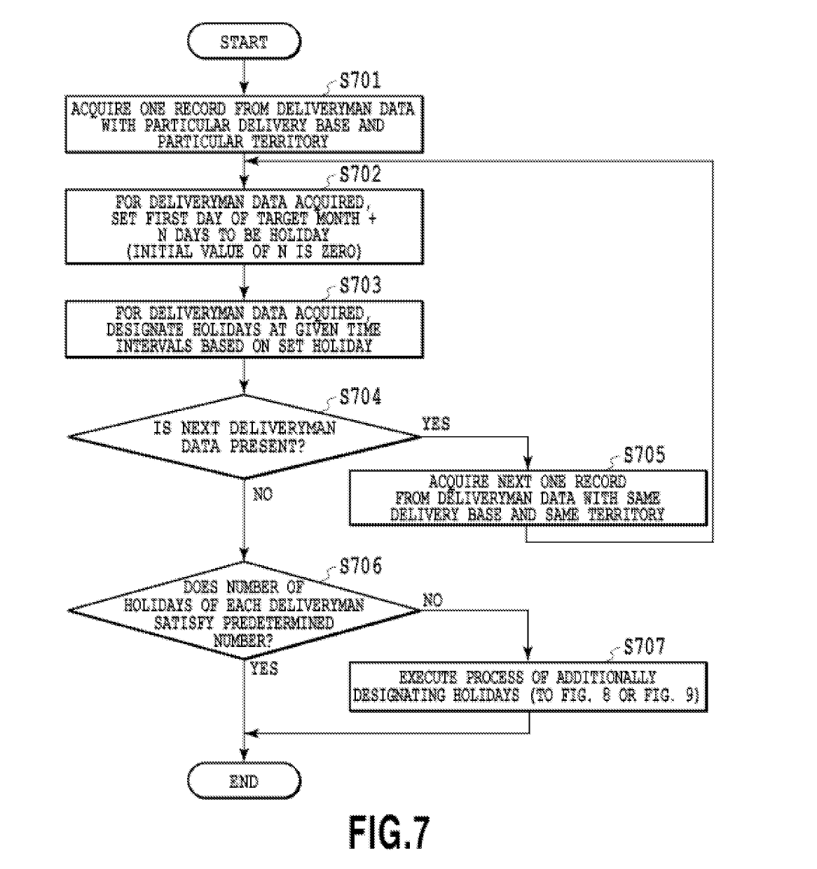

Now, with reference to a flowchart in FIG. 7 and tables in FIGS. 2 to 4, a flow of a process of creating a basic leave schedule according to one embodiment of the present invention will be described in detail.

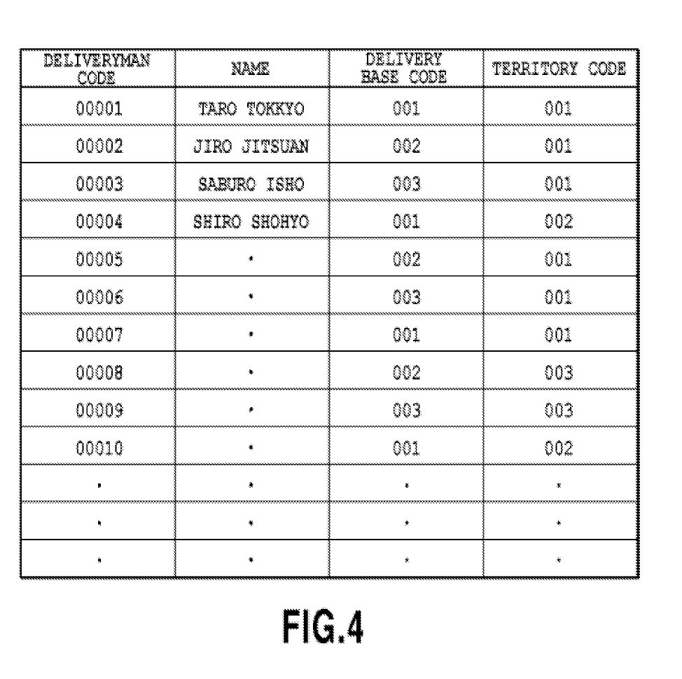

FIG. 7 is a flowchart of a process of creating a basic leave schedule according to the one embodiment of the present invention. In step 701, the business management server 100 acquires one record (data for one deliveryman) from the deliveryman data for a particular delivery base and a particular territory. In the one embodiment, the deliveryman data is “deliveryman codes” that are the identifiers of the deliverymen, the “names” of the deliverymen, “delivery base codes” that are indicative of delivery bases (for example, sales offices), and “territory codes” that are indicative of territories, as depicted in FIG. 4. The territory code may be completely unique or may be unique for each delivery base code. That is, it should be appreciated that the territory may be able to be identified for each delivery base and that, even when delivery bases A and B each have a territory 1, the territory 1 of the delivery base A is not necessarily identical to the territory 1 of the delivery base B. In either way, a data organization may allow holidays to be designated for each of the deliverymen belonging to the same delivery base and having the same territory. The territory code in FIG. 4 is unique for each delivery base code.

Step 701 will be described again taking FIG. 4 as an example. The business management server 100 acquires one record using the “delivery base code” and the “territory code” as search keys. In this case, the business management server 100 can adjust the order of acquisition of records further using terms such as priority. This is because the order of acquisition of records may relate to the order of designation of holidays.

In step 702, the business management server 100 sets the first day of a month (target month) on which schedule creation is performed for the acquired deliveryman data (since this is deliveryman data for the first deliveryman, the first data+0 day is set to be a holiday). Then, using the set holiday as a reference, the business management server 100 designates holidays at given time intervals within the range of the target month (step 703). For example, FIG. 2 is a diagram depicting an example of a basic leave schedule created by executing process steps in FIG. 7. As seen in a section for a staff member A for a first area, the first day (Friday) is designated as a holiday (step 702), and holidays are designated at given time intervals (every four days) (fifth day, ninth day, thirteenth day, . . . /step 703). It should be appreciated that the target month need not necessarily be one month but may be a period shorter than one month or several months. Furthermore, it should be appreciated that, in step 702, the day designated as a holiday first need not necessarily be the first day of the month and that a reference day may be determined so that the holidays can be set using this day as a reference.

In step 703, when the designation of the holidays within the target month ends, the business management server 100 determines whether the next deliveryman data is present (step 704). When the next deliveryman data is present, the process proceeds to a Yes route where the business management server 100 acquires the next one record with the same delivery base and the same territory from the deliveryman data (step 705). Then, in step 702, a holiday is designated, but this time, the first day+one day is set to be the holiday. When FIG. 2 is taken as an example again, then this time, the holiday for a staff member B is set to be the second day (Saturday) (step 702). In step 703, holidays are designated at given time intervals as is the case with the first record. Designating the holidays at the given periods includes not only designating days following the holiday set to be the reference but also designating days preceding the holiday set to be the reference. For example, for a staff member E in FIG. 2, the fifth day (Tuesday) is set to be a holiday, and other holidays are designated to be not only days following the fifth day, that is, the ninth day the thirteenth day, the seventeenth day, . . . , but also a day preceding the fifth day, that is, the first day (Friday) (step 703).

The above-described process (steps 702 to 705) is repeated until all the records of the deliveryman data with the same delivery base and the same territory are processed. In this manner, holidays are designated for the deliverymen for the same delivery base and the same territory intermittently.

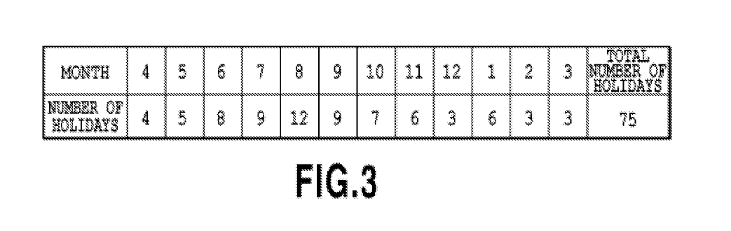

When all the records of the deliveryman data with the same delivery base and the same territory are processed, the process proceeds to a No route of step 704 where the business management server 100 determines whether the number of holidays designated for each deliveryman satisfies a predetermined number (step 706). In this regard, the predetermined number is, for example, the monthly number of holidays to be designated as depicted in FIG. 3. For example, a right column in the table in FIG. 2 depicts an item “total holidays”, and this item corresponds to the total number of holidays designated for each deliveryman during the process starting with step 702 and ending with step 705. If this schedule is for June, the number of holidays to be designated is eight, and the holidays for staff members C and D is one day short, as depicted in FIG. 3. In such a case, the business management server 100 determines that the number of holidays designated does not satisfy the predetermined number (step 706), and proceeds to a No route where the business management server 100 executes a process of additionally designating holidays (step 707).

On the other hand, when the number of holidays designated is determined to satisfy the predetermined number (Yes route of step 706) or the process of additionally designating holidays has been executed (step 707), the present process flow ends.

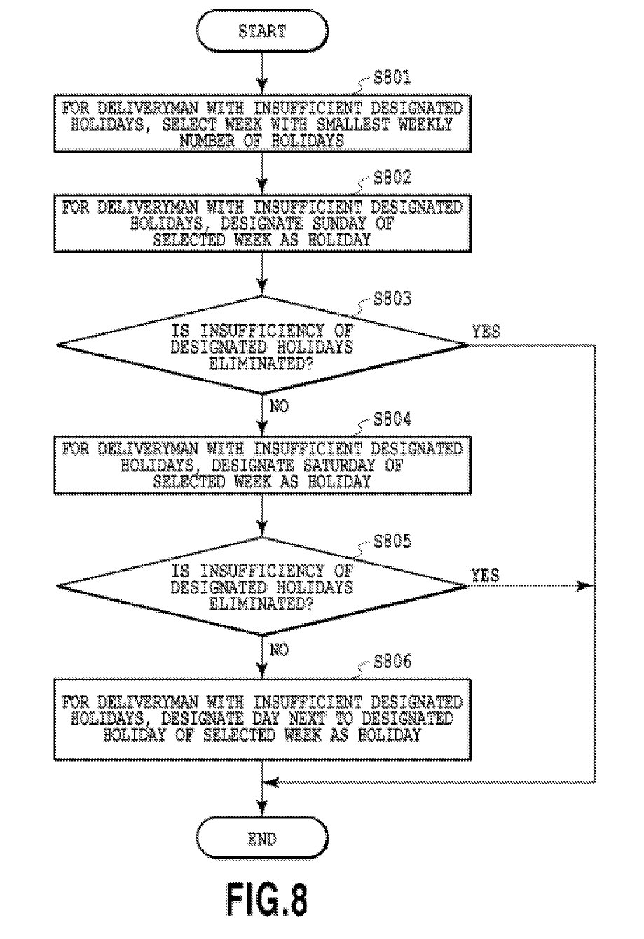

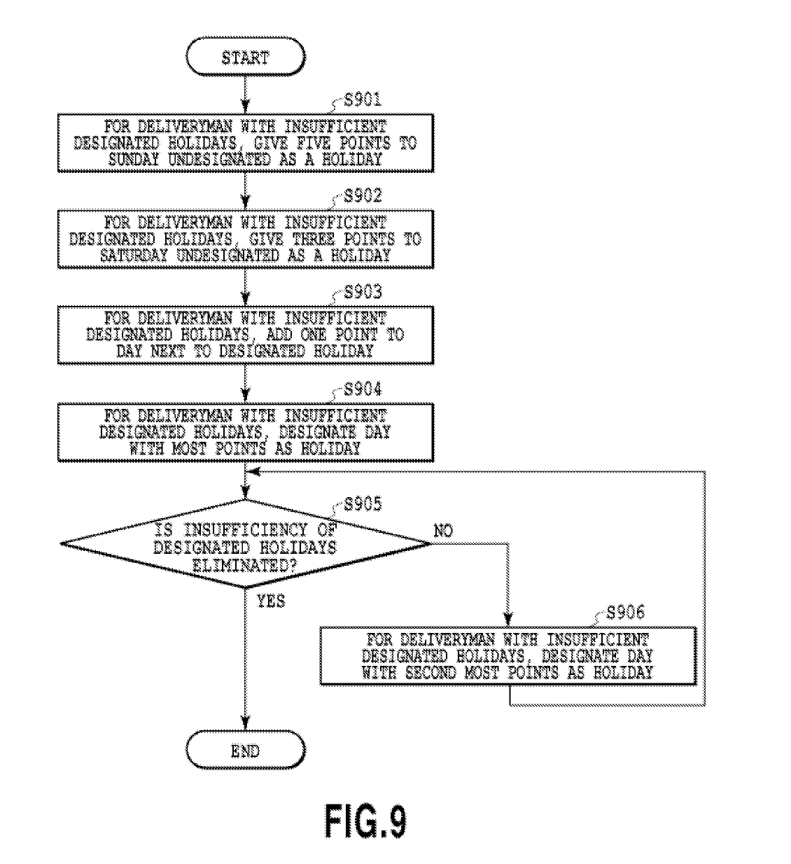

Now, the process of additionally designating holidays is executed in step 707 as follows. The additional designation process involves two embodiments that are illustrated in flowcharts in FIG. 8 and FIG. 9, respectively.

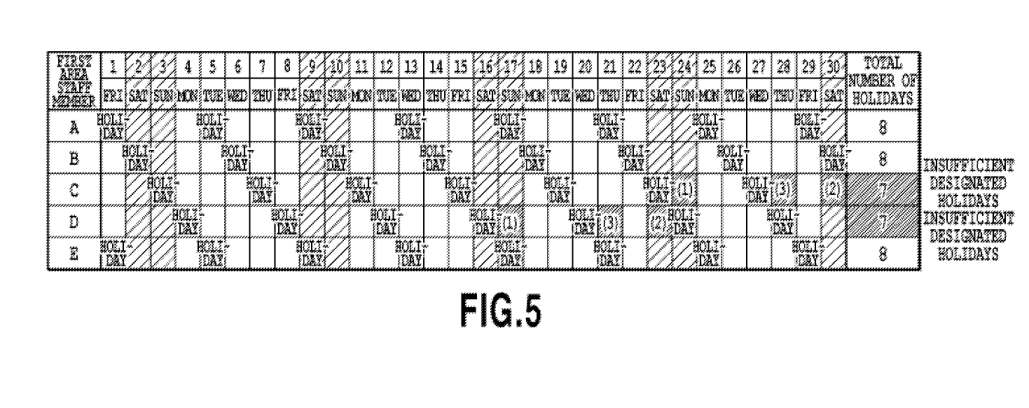

FIG. 8 is a flowchart illustrating a process of creating a leave schedule to which a priority system according to the embodiment of the present invention is applied. In the present process, as depicted in FIG. 5 (holidays are designated in a manner similar to the manner in FIG. 2), holidays are designated for staff members C and D for which designated holidays are insufficient in order of priority (depicted as parenthesized numbers in FIG. 5) preset for additional designation of holidays. In the one embodiment, the priority is as follows: the highest priority is given to (1) the Sunday of a week with the smallest weekly number of designated holidays, the second highest priority is given to (2) the Saturday of the same week, and the third priority is given to (3) a day next to the designated holiday of the same week. However, for any of these days, days already designated as holidays are excluded. Furthermore, it should be appreciated that the priorities are not limited to the above-described priorities (1) to (3) and that other days such as public holidays may be preferentially designated as holidays or the priorities may be optionally changed. A flow of the present process will be described below with reference to FIG. 8.

First, in step 801, the business management server 100 selects one of the weeks of a target month that has the smallest weekly number of designated holidays, for each deliveryman with insufficient holidays. Then, the business management server 100 designates the Sunday of the selected week as a holiday (step 802). When, in step 802, the insufficiency of designated holidays for each deliveryman is successfully eliminated, the process proceeds to a Yes route of step 803 to end the present process. When the insufficiency of designated holidays is not eliminated, the process proceeds to a No route to shift to step 804.

In step 804, the business management server 100 designates the Saturday of the week selected in step 801 as a holiday. Then, when the insufficiency of designated holidays for each deliveryman is successfully eliminated, the present process proceeds to a Yes route of step 805 to end the present process. On the other hand, when the insufficiency of designated holidays has not been eliminated yet, the process proceeds to a No route to shift to step 806.

Finally, the day next to the designated holiday of the week selected in step 801 is designated as a holiday (step 806), and the present process ends.

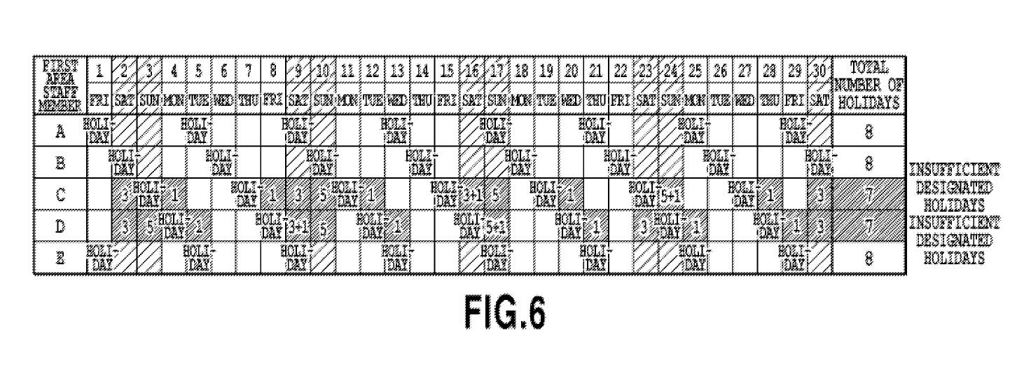

Now, an alternative embodiment of the additional designation process will be described. FIG. 9 is a flowchart illustrating a process of creating a leave schedule to which a point system according to the one embodiment of the present invention is applied. In the present process, as depicted in FIG. 6 (holidays are designated in a manner similar to the manner in FIG. 2), points are given to days undesignated as holidays in accordance with a particular rule. Furthermore, for staff members C and D with insufficient holidays, days with high points are designated as holidays in order of decreasing number of points. The particular rule is as follows: in the one embodiment, (1) five points are given to Sundays undesignated as holidays, (2) three points are given to Saturdays undesignated as holidays, and (3) one point is given to days next to the designated holidays. For example, when the day next to the designated holiday is Sunday, six points are given to this day (five points are given because the day is Sunday and one point is added because the day is also next to the designated holiday). In this case, it should be appreciated that the days to which points are given and the amount (weight) of points given may be changed.

First, in step 901, the business management server 100 gives five points to Sundays of a target month which are undesignated as holidays. Then, the business management server 100 gives three points to Saturdays of the target month which are undesignated as holidays (step 902). Moreover, the business management server 100 adds one point to the days next designated holidays (step 903). It should be appreciated that the order of steps 901 to 903 may be any order.

After giving the points in steps 901 to 903, the business management server 100 designates a day with the most points as a holiday (step 904). When, in step 904, the insufficiency of designated holidays for each deliveryman is successfully eliminated, the process proceeds to a Yes route of step 904 to end the present process. When the insufficiency of designated holidays is not eliminated, the process proceeds to a No route to shift to step 906.

In step 906, the business management server 100 designates a day with the second most points as a holiday, and repeats steps 905 and 906 until the insufficiency of designated holidays for each deliveryman is eliminated. When holidays are repeatedly designated, weeks including a holiday designated in accordance with the point system may be excluded and holidays may be designated in different weeks. Furthermore, when a plurality of days has the same number of points, a day of a week with a smaller weekly number of holidays can be selected. Moreover, when a plurality of weeks has the same weekly number of holidays, the day of the earlier week can be selected.

As embodiments of the additional designation process, the priority system (FIG. 5 and FIG. 8) and the point system (FIG. 6 and FIG. 9) have been described. To eliminate the insufficiency of designated holidays for each deliveryman, one or both of the systems may be carried out (for example, for a certain deliveryman, one holiday is designated in accordance with the priority system, and then, the point system is carried out. Alternatively, the systems are carried out in the reversed order).

1. A method for creating, by a computer, a leave schedule of a given period for a liquid petroleum (LP) gas deliveryman, the method comprising:
designating, by the computer, a reference day+n days within the given period as a holiday for deliveryman data with an identical delivery base and an identical territory stored in a storage unit on the computer, the n being an integer and being shifted by a given number for each of the deliveryman data;
designating, by the computer, holidays for the deliveryman data at given time intervals based on the designated holiday;
determining, by the computer, whether a total number of the designated holidays is equal to or larger than a predetermined number for each of the deliveryman data; and
additionally designating, by the computer, holidays for the deliveryman data with the total number smaller than the predetermined number.

2. The method according to claim 1, wherein additionally designating holidays includes designating the holiday in order of given priority.

3. The method according to claim 1, wherein additionally designating holidays includes designating days within the given period as holidays in order of decreasing number of points given to each of the days in accordance with a given rule.

4. The method according to claim 2, wherein the given priority is such that a highest priority is given to a Sunday of a week with a smallest weekly number of holidays in the given period, a second highest priority is given to a Saturday of the week, and a third highest priority is given to a day next to the designated holiday of the week.

5. The method according to claim 3, wherein the points are given to Sunday and Saturday within the given period which are not the designated holidays, and an additional point for the points are given to a day next to the designated holiday.

6. A computer-readable storage medium storing computer executable instructions to allow a computer to execute a method for creating a leave schedule of a given period for a liquid petroleum (LP) gas deliveryman, the computer program, when executed by the computer, allowing the computer to execute the following steps of:
designating a reference day+n days within the given period as a holiday for deliveryman data with an identical delivery base and an identical territory stored in a storage unit on the computer, the n being an integer and being shifted by a given number for each of the deliveryman data;
designating holidays for the deliveryman data at given time intervals based on the designated holiday;
determining whether a total number of the designated holidays is equal to or larger than a predetermined number for each of the deliveryman data; and
additionally designating holidays for the deliveryman data with the total number smaller than the predetermined number.

7. A computer for creating a leave schedule of a given period for a liquid petroleum (LP) gas deliveryman, the computer comprising:
a unit designating a reference day+n days within the given period as a holiday for deliveryman data with an identical delivery base and an identical territory stored in a storage unit on the computer, the n being an integer and being shifted by a given number for each of the deliveryman data;
a unit designating holidays for the deliveryman data at given time intervals based on the designated holiday;
a unit determining whether a total number of the designated holidays is equal to or larger than a predetermined number for each of the deliveryman data; and
a unit additionally designating holidays for the deliveryman data with the total number smaller than the predetermined number.
